(19) United States
(12) Patent Application Publication
(10) Pub. No.: US 2023/0325750 A1
(43) Pub. Date: Oct. 12, 2023

(54) EXPERT MATCHING SYSTEM FOR SUPPORTING STARTUP

(71) Applicant: BOXLADDER CO.,LTD., Seoul (KR)

(72) Inventor: Chul Man CHOI, Seoul (KR)

(73) Assignee: BOXLADDER CO.,LTD., Seoul (KR)

(21) Appl. No.: 18/207,154

(22) Filed: Jun. 8, 2023

Related U.S. Application Data
(63) Continuation of application No. PCT/KR2021/015197, filed on Oct. 27, 2021.

(30) Foreign Application Priority Data
Dec. 24, 2020 (KR) 10-2020-0182931

(51) Int. Cl. G06Q 10/0637

(52) U.S. Cl. CPC G06Q 10/0637

(57) ABSTRACT

An expert matching system for supporting a startup includes: a startup terminal requesting and receiving startup consulting; an expert terminal providing startup consulting requested by the startup terminal; and an expert matching server analyzing the startup consulting requested by the startup terminal, searching for an expert, and matching a relevant expert terminal with the startup terminal.

### TECHNICAL FIELD

The present invention relates to a startup support system, and more specifically, to an expert matching system for supporting a startup.

### BACKGROUND ART

A startup company has the characteristics of starting with as few as 1-2 people and developing the business quickly.

Starting with a small number of people, there is a disadvantage that there is a lack of expertise in various fields such as management, marketing, purchasing, finance, overseas export/import regions, and technology. Accordingly, various institutions provide accelerator programs so that start-up companies can receive various professional supports.

Institutions that operate accelerators or mentoring have various expert pools in marketing, purchasing, finance, technology, etc., but there is a problem that the number of experts in the expert pool or fields is limited, and there is a disadvantage that it is almost impossible to receive more detailed and direct consulting necessary for the business.

Accordingly, most start-up companies have no choice but to be satisfied with the extent to which 1-2 experts in similar professional fields participate in consulting and provide consulting within the scope of their knowledge. In other words, the range of experts that can be selected is too limited.

Furthermore, even when the help of expert is necessary with respect to information on overseas exporters or overseas importers, it is not easy to find an expert for a specific country or region.

Therefore, there is an urgent need for a means to seek accurate advice by finding direct experts who are essential for the business.

### DISCLOSURE

### Technical Problem

An object of the present invention is to provide an expert matching system for supporting a startup.

### Technical Solution

According to the object of the present invention, an expert matching system for supporting a startup may be configured to include: a startup terminal requesting and receiving startup consulting; an expert terminal providing startup consulting requested by the startup terminal; and an expert matching server analyzing the startup consulting requested by the startup terminal, searching for an expert, and matching a relevant expert terminal with the startup terminal.

Here, the expert terminal may be configured to provide startup consulting for at least one area of management, finance, purchasing, marketing, and technology for the startup.

In addition, the expert matching server may be configured for the expert terminal to provide the startup consulting to the startup terminal online.

### Advantageous Effects

According to the above-described expert matching system for supporting a startup, it is configured to search for experts from a pool of experts prepared in advance as well as search for necessary experts on SNS pages or web pages in real time to match startup companies and experts, so there is the effect of providing direct expert consulting that businesses need.

In addition, since the expert information of the expert pool is updated by reflecting the expert's consulting history and consulting evaluation, it is possible to accurately search for and match an expert even when a similar consulting request is made in the future.

### DESCRIPTION OF DRAWING

FIG. 1 is a block diagram of an expert matching system for supporting a startup according to an embodiment of the present invention.

### BEST MODE

The present invention may have various modifications and various exemplary embodiments and detailed contents for illustrating specific exemplary embodiments in the drawings and carrying out the present invention will be described in detail. However, this does not limit the present invention to specific exemplary embodiments, and it should be understood that the present invention covers all the modifications, equivalents and replacements included within the idea and technical scope of the present invention. In describing each drawing, reference numerals refer to like elements.

The terms including as first, second, A, B, and the like are used for describing various constituent elements, but the constituent elements are not limited by the terms. The terms are used only to discriminate one component from another component. For example, a first component may be referred to as a second component, and similarly, the second component may be referred to as the first component without departing from the scope of the present invention. A term ‘and/or’ includes a combination of a plurality of associated disclosed items or any item of the plurality of associated disclosed items.

It should be understood that, when it is described that a component is “connected to” or “accesses” another component, the component may be directly connected to or access the other component or a third component may be present therebetween. In contrast, when it is described that a component is “directly connected to” or “directly accesses” another component, it is understood that no element is present between the element and another element.

The terms used in the present application are used only to describe specific exemplary embodiments, and are not intended to limit the present invention. A singular form includes a plural form unless the context clearly dictates otherwise. In the present application, it should be understood that the term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

Unless otherwise defined, all terms used herein including technological or scientific terms have the same meanings as those generally understood by a person with ordinary skill in the art. The terms which are defined in a generally used dictionary should be interpreted to have the same meaning as the meaning in the context of the related art, and are not interpreted as an ideal meaning or excessively formal meanings unless clearly defined in the present application.

Hereinafter, preferred embodiments of the present invention will be described in detail with reference to the accompanying drawings.

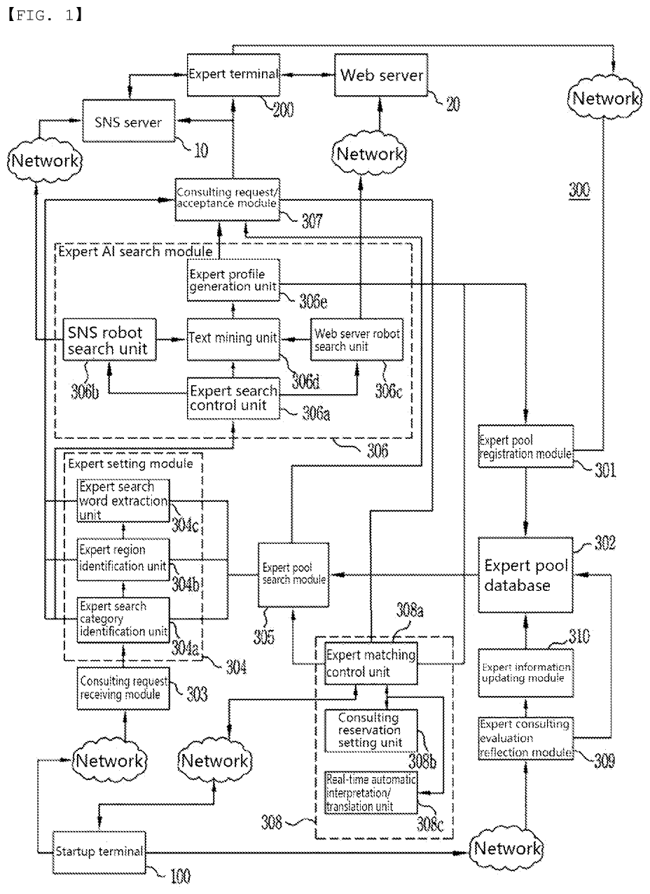

FIG. 1 is a block diagram of an expert matching system for supporting a startup according to an embodiment of the present invention.

Referring to FIG. 1, an expert matching system 100 for supporting a startup according to an embodiment of the present invention is configured to include a startup terminal 100, an expert terminal 200, and an expert matching server 300.

Hereinafter, a detailed configuration will be described.

The startup terminal 100 may be configured to request and receive startup consulting. The startup consulting can be consulting in various fields such as management, finance, purchasing, taxation, import/export, and technology.

The expert terminal 200 may be configured to provide the startup consulting requested by the startup terminal 100 to the corresponding startup terminal 100. It can be provided online through real-time video call, and if necessary, specific data can be additionally provided through e-mail or file transmission on other systems.

The expert matching server 300 may be configured to search for experts by analyzing the startup consulting requested by the startup terminal 100 and to match the corresponding expert terminal 200 and the startup terminal 100. Here, the expert matching server 300 may receive consulting costs according to the number of consulting cases or consulting time from start-up companies and pay the consulting costs to the experts, and may receive a fee of a certain rate.

The expert matching server 300 includes an expert pool registration module 301, an expert pool database 302, a consulting request receiving module 303, an expert setting module 304, an expert pool search module 305, an expert AI search module 306, a consulting request/acceptance module 307, an expert matching module 308, an expert consulting evaluation reflection module 309, and an expert information update module 310.

Hereinafter, a detailed configuration will be described.

The expert pool registration module 301 may be configured to receive expert registration for the startup from the expert terminal 200 and register the corresponding expert in an expert pool. The pool of experts may be formed in advance of startup consulting. Recruiting experts to form an expert pool may take some time and may be limited in number.

The expert pool database 302 may be configured to store the expert pool. As information of each expert, profile information, professional consulting field, and consulting history of the corresponding expert may be stored.

The consulting request receiving module 303 may be configured to receive the request for the startup consulting from the startup terminal 100.

The expert setting module 304 may be configured to set an expert corresponding to the request received by the consulting request receiving module 303. Here, the expert may be seen as a kind of ‘virtual’ expert required for the startup consulting. For example, if you want to export quarantine products to Wuhan, China, you need to find an expert required for the business. To this end, experts in Wuhan, China, experts on exports to China, and experts on quarantine products are needed.

The expert setting module 304 may be configured to include an expert search category identification unit 304a, an expert region identification unit 304b, and an expert search word extraction unit 304c.

Hereinafter, a detailed configuration will be described.

The expert search category identification unit 304a may be configured to analyze a request for startup consulting received from the consulting request receiving module 303 and identify an expert search category required for the startup consulting. In the case of exporting quarantine clothing to Wuhan, China as exemplified above, three expert search categories may be identified: Wuhan, China, exports to China, and quarantine products.

The expert region identification unit 304b may be configured to analyze the request for startup consulting received from the consulting request receiving module 303 and identify a region of an expert required for the startup consulting. Here, a specific region called Wuhan, China may be identified.

The expert search word extraction unit 304c may be configured to analyze the request for startup consulting received from the consulting request receiving module 303 and extract an expert search word required for expert search. Here, in the case of the previous example, search words such as ‘China’, ‘Wuhan’, ‘export’, and ‘quarantine product’ may be extracted.

The expert pool search module 305 may be configured to search for the expert set in the expert setting module 304 in the expert pool of the expert pool database 302. An expert may be searched for using the expert search category, the expert region, the expert search word, etc. identified above.

The expert AI search module 306 may be configured to automatically search for the expert set in the expert setting module 304 in an SNS server 10 or a web server 20 in real time. Due to limitations of the expert pool formed in advance, the expert AI search module 306 may be configured to directly AI search experts in real time.

That is, the consulting request of the startup terminal 100 may be analyzed, and an expert directly needed therein may be searched in real time on the SNS server 10 or the web server 20 to recruit the expert. This has the advantage of being able to recruit more direct and professional experts and improving the quality of consulting.

Meanwhile, an expert by AI search may be newly registered in the expert pool database 302 by the expert pool registration module 301. Accordingly, the expert pool may be gradually expanded.

The expert AI search module 306 may be configured to include an expert search control unit 306a, an SNS robot search unit 306b, a web server robot search unit 306c, a text mining unit 306d, and an expert profile generation unit 306e.

Hereinafter, a detailed configuration will be described.

The expert search control unit 306a may be configured to control the search of experts set in the expert setting module 304.

The SNS robot search unit 306b may be configured to perform real-time robot search for SNS user information on the SNS server 10 under the control of the expert search control unit 306a.

For example, the SNS robot search unit 306b may search for various SNS user information by searching a Facebook page. SNS user information may be searched using keywords such as China, Wuhan, and quarantine products. In the case of Facebook, the country range of users is very wide, and the number of users also reaches billions. It has the advantage of being able to search for experts from a diverse pool of users worldwide.

And the SNS robot search unit 306b may search in various languages. Due to the diversity of search languages, it is possible to secure a wider search range.

The web server robot search unit 306c may be configured to robot search expert information on the web server 20 in real time under the control of the expert search control unit 306a.

The web page may include various web pages such as a personal home page, a company home page, and a blog.

The text mining unit 306d may be configured to analyze SNS user information robot-searched by the SNS robot search unit 306b and expert information robot-searched by the web server robot search unit 306c by using text mining. The text mining unit 306d may find the expert by more accurate and specific analysis through text mining.

The expert profile generation unit 306e may be configured to generate an expert profile for the startup consulting according to the analysis of the text mining unit 306d. The expert profile generation unit 306e may find an expert required for a specific startup consulting and create a new expert profile. Here, the newly created expert profile may be newly registered in the expert pool database 302 through the expert pool registration module 301.

On the other hand, the expert AI search module 306 may be configured to search for an AI expert in real time even in normal times, instead of searching for an expert AI only when there is a request for consulting. That is, a virtual consulting request module (not illustrated) may generate a virtual consulting request. The virtual consulting request may expect currently the most consulting requests by analyzing various big data databases (not illustrated) related to the startup in a startup big data analysis module (not illustrated). Using this, a virtual consulting request module (not illustrate) may create a virtual consulting request in real time to secure an expert pool in advance. For example, if a shortage phenomenon of ‘mask’ suddenly increases in Korea due to ‘Corona’, a virtual consulting request called ‘Manufacture of domestic corona prevention mask’ is created to AI-search related experts in advance and expand the expert pool. Here, the expert setting module 304 may be configured to receive a virtual startup consulting request from a virtual consulting request module (not illustrated) and set an expert corresponding to the virtual startup consulting request.

The consulting request/acceptance module 307 automatically requests the startup consulting to the expert terminal 200 of the expert searched by the expert pool search module 305 or the expert searched by the expert AI search module 306, and receive the consulting acceptance from the corresponding expert terminal 200. The expert may check startup consulting requests and selectively accept consulting.

The expert matching module 308 may be configured to mutually match the startup terminal 100 and the expert terminal 200 receiving the consulting acceptance from the consulting request/acceptance module 307. If there are several consulting acceptances, the expert matching module 308 may be configured to create a consulting acceptance list and provide the consulting acceptance list to the startup terminal 100, and perform mutual matching according to the selection of the startup terminal 100. Here, the consulting acceptance list may include the expert profile of each expert, the consulting history, and the evaluation of the startup's expert consulting.

The expert matching module 308 may be configured to include an expert matching control unit 308a, a consulting reservation setting unit 308b, and a real-time automatic interpretation/translation unit 308c.

Hereinafter, a detailed configuration will be described.

The expert matching module 308 may be configured to mutually match the startup terminal 100 and the expert terminal 200 receiving the consulting acceptance from the consulting request/acceptance module 307.

The consulting reservation setting unit 308b may be configured to reserve and set a consulting schedule between the startup terminal 100 and the expert terminal 200 under the control of the expert matching control unit 308a. The consulting reservation setting unit 308b may be configured to make a consulting reservation by mutually contrasting the startup company's online access time and the expert's online access time. Here, if the expert is a foreigner residing in a foreign country, a consulting reservation may be configured to be performed by reflecting the time difference.

The real-time automatic interpretation/translation unit 308c may be configured to provide a real-time automatic interpretation/translation function between the startup terminal 100 and the expert terminal 200 on a consulting schedule reserved and set in the consulting reservation setting unit 308b for communication between the startup terminal 100 and the expert terminal 200. In the previous example, assuming that an expert matching is made with a Chinese quarantine expert residing in Wuhan, China, or a local Chinese management consulting expert who is familiar with various situations in Wuhan, China, real-time consulting by providing a real-time interpretation/translation function over an online video call. In this way, due to the nature of startups, quick, prompt and direct consulting may be made.

Meanwhile, the expert matching server 300 may further include a global investor matching module (not illustrated) in addition to the expert matching module 308. Here, the global investor matching module (not illustrated) may be configured to host an online meeting between startup officials, experts, and global investors by additionally matching pre-registered global investor terminals (not illustrated). The global investors may participate in consulting and provide advice or consultations for their opinions or investment.

The expert consulting evaluation reflection module 309 receives the expert consulting evaluation for the startup consulting of the expert matched by the expert matching module 308 from the startup terminal 100 and reflects the expert consulting evaluation to the expert pool database 302. When a specific expert provides consulting through the expert matching server 300, the startup company receiving the consulting may perform various evaluations on the quality of the consulting, service, and the like. Through this evaluation, other start-up companies may determine whether to accept the expert's consulting. If the expert's consulting evaluation continues to be low, the startup company will not make a choice.

The expert information updating module 310 may be configured to update information about a major consulting field and consulting history of a corresponding expert in the expert pool database 302 according to the expert consulting evaluation received in the expert consulting evaluation reflection module 309. If the expert's consulting history increases, other start-up companies may refer to the expert's consulting history. On the other hand, as the expert's consulting increases, the expert's main consulting fields and features are also updated and stored in the expert pool, so if consulting on a specific detailed field is received, the expert pool search module 305 may preferentially search for an expert having a strength in the specific detailed field. That is, as the history of consulting increases, the field in which the expert's actual strength is revealed is updated in the expert information, so that the accuracy of expert matching can be increased.

The present invention has been described with reference to the exemplary embodiments. However, it will be appreciated by those skilled in the art that various modifications and changes of the present invention can be made without departing from the spirit and the scope of the present invention which are defined in the appended claims and their equivalents.

1. An expert matching system for supporting a startup, comprising:
a startup terminal requesting and receiving startup consulting;
an expert terminal providing startup consulting requested by the startup terminal; and
an expert matching server analyzing the startup consulting requested by the startup terminal, searching for an expert, and matching a relevant expert terminal with the startup terminal.

2. The expert matching system for supporting a startup of claim 1, wherein the expert terminal is configured to provide startup consulting for at least one area of management, finance, purchasing, marketing, and technology for the startup.

3. The expert matching system for supporting a startup of claim 1, wherein the expert matching server is configured for the expert terminal to provide the startup consulting to the startup terminal online.
